(19) United States
(12) Patent Application Publication
(10) Pub. No.: US 2008/0029977 A1
(43) Pub. Date: Feb. 7, 2008

(54) Chuck for a photoresist spin coater

(75) Inventors: Jui-Chung Cheng, Hsinchu (TW); Chian-Sheng Chang, Hsinchu (TW)

Correspondence Address: CHARLES E. BAXLEY, ESQ., 90 JOHN STREET, THIRD FLOOR, NEW YORK, NY, 10038, US

(73) Assignee: Prime View International Co., Ltd.

(21) Appl. No.: 11/499,131

(22) Filed: Aug. 3, 2006

(51) Int. Cl. B23B 31/12

(52) U.S. Cl. 279/28

(57) ABSTRACT

A chuck for a photoresist spin coater has a bracket and a disk. The bracket is electrically conductive. The disk is mounted on the base, holds a glass substrate and is electrically conductive. Therefore, The disk allows static electricity on the disk to discharge to protect the glass substrate from being damaged by the static electricity when the glass substrate removes from the chuck.

### BACKGROUND OF THE INVENTION

1. Field of the Invention

The present invention relates to a chuck, and especially to a chuck for a photoresist spin coater that protects a glass substrate on the chuck from being damaged by static electricity when the glass substrate removes from the chuck.

2. Description of the Related Art

Liquid crystal displays (LCDs) have gradually come to dominate the display market because the LCD is thin and light and has a glass substrate. A process for producing the LCD comprises forming thin-film transistors and circuits on the glass substrate by using a photolithography process. The photolithography process coats a layer of a photoresist homogeneously on the glass substrate and then transfers a pattern from a mask to the photoresist layer before conducting a development process.

With reference to FIG. 5, a conventional method for coating the photoresist on the glass substrate is via a photoresist spin coater. The photoresist spin coater comprises a motor, a vacuum pump, a shaft (90) and a chuck (91). The shaft (90) is connected rotatably with and driven by the motor. The chuck (91), which is a suction disk, is made of insulating material, is mounted on the shaft (90) and is connected to and communicates with the vacuum pump through tubes. The vacuum pump may provide a suction effect in the chuck (91).

When coated with the photoresist, a glass substrate (92) is put on the top of the chuck (91) and the photoresist is dispensed on a center of the glass substrate (92). Then, the vacuum pump is turned on to draw and hold the glass substrate (92) in place and the motor operates to rotate the shaft (90) with the chuck (91) to spin the glass substrate (92) together. Therefore, the photoresist radially spreads out from the center to a whole surface of the glass substrate (92) due to a centrifugal force.

After coating the photoresist liquid on the glass substrate (92), the glass substrate (92) removes from the chuck (91). However, the glass substrate (92) removing the chuck (91) results in the top of the chuck (91) having static electricity of about 15 to 16 kilovolts (KV). The static electricity with high volt harms circuits on the glass substrate (92) so that the production rate of the glass substrate (92) reduces.

### SUMMARY OF THE INVENTION

The objective of the present invention is to provide a chuck for a photoresist spin coater that protects a glass substrate on the chuck from being damaged by static electricity when the glass substrate removes from the chuck.

To achieve the foregoing objective, a chuck for a photoresist spin coater in accordance with the present invention comprises a bracket and a disk. The bracket is static electrically conductive. The disk is mounted on the base, holds a glass substrate and is static electrically conductive. Therefore, The disk allows static electricity on the disk to discharge to protect the glass substrate from being damaged by the static electricity when the glass substrate removes from the chuck.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a chuck for a photoresist spin coater in accordance with the present invention on the base.

FIG. 2 is an enlarged perspective view of the photoresist spin coater with the chuck in FIG. 1;

FIG. 3 is a side view in partial section of the photoresist spin coater with the chuck in FIG. 2 on the base;

FIG. 4 is a side view in partial section of the photoresist spin coater with the chuck in FIG. 2 on the base and arrows indicate a pathway of electric conduction;

FIG. 5 is a perspective view of a conventional photoresist spin coater in accordance with the prior art.

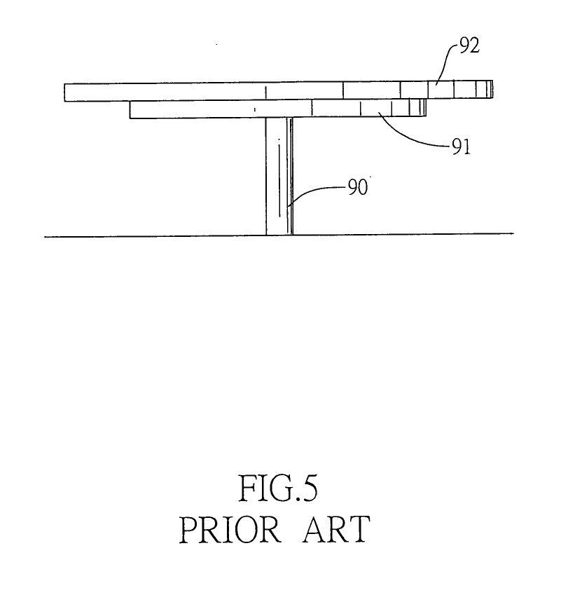

### DETAILED DESCRIPTION OF THE PREFERRED EMBODIMENTS

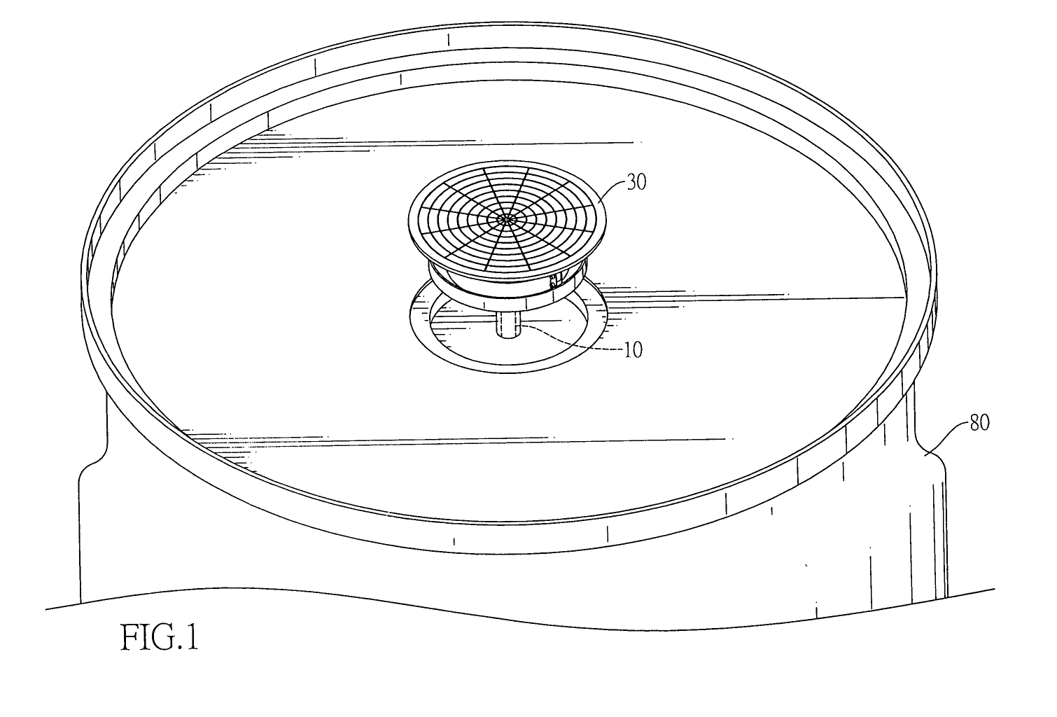

With reference to FIGS. 1 to 3, a chuck in accordance with the present invention is mounted with a photoresist spin coater. The photoresist spin coater is mounted on a base (80) grounded and has a motor, a shaft (10) and a vacuum pump. The motor and the vacuum pump are fixed on a base (80). The shaft (10) is static electrically conductive, is mounted on the base (80), is connected rotatably to and is driven by the motor and has a top end and a mounting slot (11) defined transversely in the shaft (10) close to the top end.

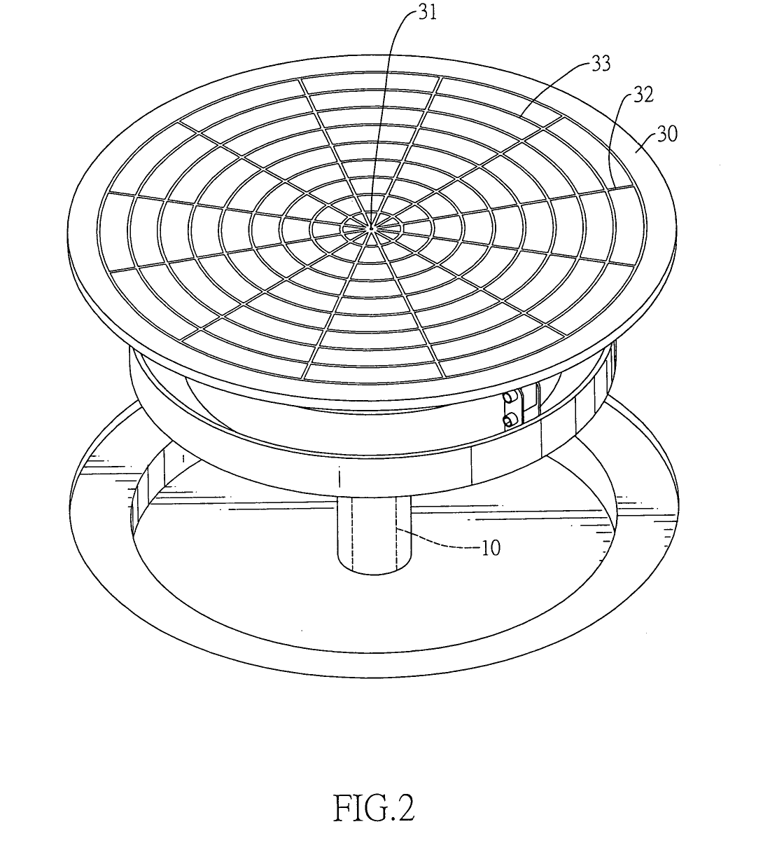

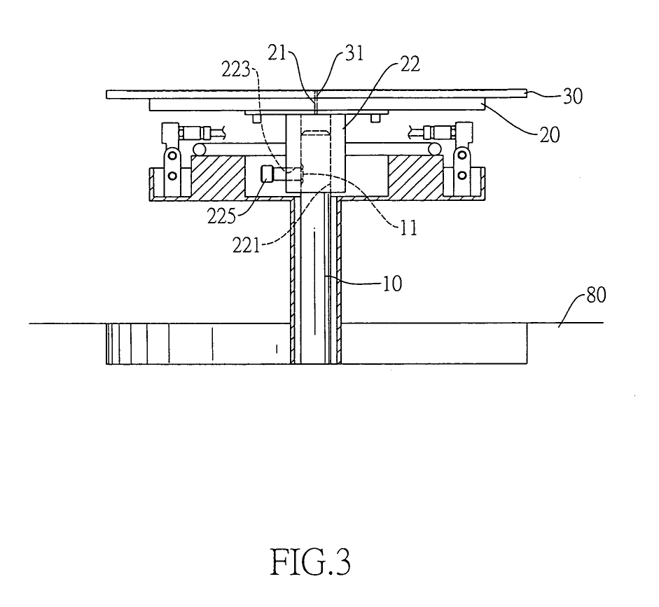

With reference to FIGS. 2 and 3, the chuck is mounted on the top end of the shaft (10) and comprises a bracket (20) and a disk (30).

The bracket (20) is made of static electrically conductive material such as metal to conduct electricity. The bracket (20) is detachably mounted on the top end of the shaft (10) and comprises a center, a bottom, a central hole (21) and a sleeve (22). The central hole (21) is defined through the center of the bracket (20) and communicates with the vacuum pump through a tube so that the vacuum pump may provide a suction effect in the central hole (21). The sleeve (22) protrudes down from the bottom of the bracket (20), is mounted around the top end of the shaft (10) and comprises a cavity (221), a positioning hole (223) and a bolt (225). The cavity (221) is defined axially in the sleeve and receives the top end of the shaft (10). The positioning hole (223) is defined radially in the sleeve (22), communicates with the cavity (221) and is threaded. The bolt (225) is mounted detachably through the positioning hole (223) and extends into the mounting slot (11) in the shaft (10) so that the shaft (10) and the base (20) can be fastened together.

The disk (30) is mounted on the base (20), may contact and hold a glass substrate, is made of static electrically conductive material such as carbon, graphite, metal and the like to conduct electricity. Preferably, a resistivity of the disk (30) is 10³ to 10⁵ ohms/sq. The disk (30) comprises a center, a top, a through hole (31), multiple radial gaps (32) and multiple annular gaps (33). The through hole (31) is defined through the center of the disk (30) and communicates with the central hole (21) in the bracket (20). The radial gaps (32) are defined in the top of the disk (30) and communicate with the through hole (31). The annular gaps (33) are defined in the top of the disk (30), communicate with the radial gaps (32) and are arranged concentrically. When the vacuum pump operates, the suction effect provided by the vacuum pump reaches in the radial and annular gaps (31, 32) to securely hold a glass substrate on the chuck.

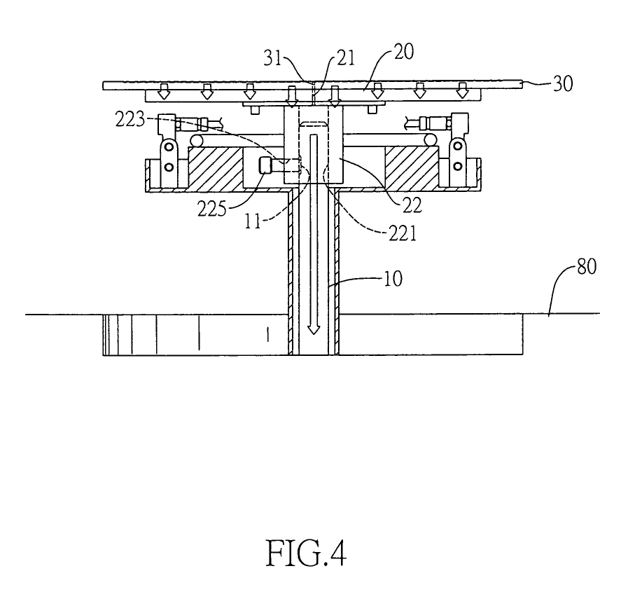

With reference to FIGS. 2 and 4, the disk (30), the bracket (20), the shaft (10), the motor and the base (80) are formed as a static electricity discharging pathway. After the glass substrate is coated with the photoresist, the static electricity on the disk (30) passes through the static electricity discharging pathway to the ground and protects the glass substrate from being damaged by the static electricity when the glass substrate is removed from the chuck.

Therefore, the disk (30), the base (20), the chuck with the disk (30) allows the static electricity to discharge through the static electricity discharging pathway so the glass substrate on the disk is not damaged by the static electricity. Therefore, a production rate of the glass substrate is increased.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A chuck for a photoresist spin coater comprising
a bracket made of static electrically conductive material; and
a disk mounted on the bracket, made of static electrically conductive material.

2. The chuck for a photoresist spin coater as claimed in claim 1, wherein the disk is made of carbon.

3. The chuck for a photoresist spin coater as claimed in claim 1, wherein the disk is made of graphite.

4. The chuck for a photoresist spin coater as claimed in claim 1, wherein the disk is made of metal.

5. The chuck for a photoresist spin coater as claimed in claim 2, wherein a resistivity of the disk is 10³ to 10⁵ ohms/sq.

6. The chuck for a photoresist spin coater as claimed in claim 3, wherein a resistivity of the disk is 10³ to 10⁵ ohms/sq.

7. The chuck for a photoresist coater as claimed in claim 4, wherein a resistivity of the disk is 10³ to 10⁵ ohms/sq.

8. The chuck for a photoresist spin coater as claimed in claim 5, wherein the bracket has
a bottom; and
a sleeve protruding down from the bottom of the bracket, mounted around a rotating shaft and having
a cavity defined axially in the sleeve;
a positioning hole defined radially in the sleeve and communicating with the cavity; and
a bolt mounted detachably through the positioning hole.

9. The chuck for a photoresist spin coater as claimed in claim 6, wherein the bracket has
a bottom; and
a sleeve protruding down from the bottom of the bracket and having
a cavity defined axially in the sleeve;
a positioning hole defined radially in the sleeve and communicating with the cavity; and
a bolt mounted detachably through the positioning hole.

10. The chuck for a photoresist spin coater as claimed in claim 7, wherein the bracket has
a bottom; and
a sleeve protruding down from the bottom of the bracket and having
a cavity defined axially in the sleeve;
a positioning hole defined radially in the sleeve and communicating with the cavity; and
a bolt mounted detachably through the positioning hole.

11. The chuck for a photoresist spin coater as claimed in claim 8, wherein:
the bracket further comprises a center and a central hole defined through the center of the bracket and adapted for communicating with a vacuum pump through a tube; and
the disk further comprises a center and a through hole defined through the center of the disk and communicating with the central hole of the bracket.

12. The chuck for a photoresist spin coater as claimed in claim 9, wherein
the bracket further comprises a center and a central hole defined through the center of the bracket and adapted for communicating with a vacuum pump through a tube; and
the disk further comprises a center and a through hole defined through the center of the disk and communicating with the central hole of the bracket.

13. The chuck for a photoresist spin coater as claimed in claim 9, wherein
the bracket further comprises a center and a central hole defined through the center of the bracket and adapted for communicating with a vacuum pump through a tube; and
the disk further comprises a center and a through hole defined through the center of the disk and communicating with the central hole of the bracket.

14. The chuck for a photoresist spin coater as claimed in claim 11, wherein the disk further comprises a top, multiple radial gaps defined in the top of the disk and communicating with the through hole and multiple annular gaps defined in the top of the disk and communicating with the radial gaps.

15. The chuck for a photoresist spin coater as claimed in claim 12, wherein the disk further comprises a top, multiple radial gaps defined in the top of the disk and communicating with the through hole and multiple annular gaps defined in the top of the disk and communicating with the radial gaps.

16. The chuck for a photoresist spin coater as claimed in claim 13, wherein the disk further comprises a top, multiple radial gaps defined in the top of the disk and communicating with the through hole and multiple annular gaps defined in the top of the disk and communicating with the radial gaps.
